(19) United States
(12) Patent Application Publication
(10) Pub. No.: US 2024/0228014 A9
(43) Pub. Date: Jul. 11, 2024

(54) FOLDING VERTICAL FIN-RUDDER ADAPTED FOR USE IN AIRCRAFT, EQUIPPED WITH A PYROTECHNIC CATAPULT

(71) Applicant: Pavlos Giannakopoulos, Patra (GR)

(72) Inventor: Pavlos Giannakopoulos, Patra (GR)

(21) Appl. No.: 18/480,337

(22) Filed: Oct. 3, 2023

(30) Foreign Application Priority Data
Oct. 21, 2022 (GR) 20220100862

(51) Int. Cl. B64C 5/10; B64C 5/02; B64D 25/10

(52) U.S. Cl. CPC B64C 5/10; B64C 5/02; B64D 25/10

(57) ABSTRACT

The folding vertical fin (30) adapted for use in aircraft, with its internal pyrotechnic catapult (35) on the fuselage (39) at the tail of a fighter jet (40) and turbo-prop aircraft (41), proposed in the present invention is a fully active system consisting of a fixed segment (2) for attachment onto the fuselage (39) at the tail of the aircraft and a movable segment (3) coupled to the fixed segment (2) by means of an articulation of hinges (25) at the base thereof. Said system has the capacity in an emergency to activate the internal pyrotechnic catapult (35) thereof by means of a radio signal (47a) emitted by the pulling of the ejection initiation handle (47), with said pyrotechnic catapult (35) arranged to move and fold the movable segment (3) in relation to the fixed segment (2), and said movable segment (3) of the vertical fin (30) is folded horizontally at the base thereof on the fuselage (39) at the tail of the aircraft (40), (41) thereby freeing up the volume it occupied prior to activation, resulting in the following:
1) survival of the pilots in an emergency.
2) reduction in the ejection speed of the seat (44) with its occupant.
3) application of the fin (30) to the faster fighter jets of the future.

### CROSS-REFERENCE TO RELATED APPLICATIONS

This application claims benefit of Greek Application No. 20220100862 filed Oct. 21, 2022, the specification(s) of which is incorporated herein in their entirety by reference.

### THE FIELD OF THE ART

The survival of pilots during the ejection of their seats in an emergency is of utmost importance and the vertical fin may consist a cause of injury of ejecting pilots in the case of a collision thereof with said fin.

The present invention also concerns aircraft equipped with an ejection seat and relates to the field of the art of aircraft with a folding vertical fin and with the movable tail rudder articulated at the rear end thereof, both mounted on the rear end of the aircraft's fuselage to provide control, stability, and yaw damping.

The folding vertical fin of the invention, equipped with an internal pyrotechnic catapult, constitutes a fully active system and consists of a fixed segment for attachment to the aircraft fuselage, and a movable segment coupled at the base thereof with said fixed segment by means of an articulation of hinges capable of being released in an emergency by virtue of the internal pyrotechnic catapult, with said catapult being configured to unlock-release the hinge pins and move-rotate the movable segments of the fin and vertical rudder relative to the fixed segments thereof, and with said movable segments folding horizontally at the base thereof on the tail of the aircraft thereby releasing the space they occupied prior to actuation thereof.

### THE BACKGROUND OF THE INVENTION

The vertical fin of the invention comprises the lower fixed segment and the movable segment. The movable segment is situated above the fixed segment and they are connected by means of an articulation of hinges

The articulation of hinges extends to both sides of the fixed and movable vertical fin segments between a front and a rear edge of the vertical fin so that the movable segment can rotate relative to the fixed segment around a rotation axis X of the articulation of hinges during an emergency.

Within the vertical fin there are the left and right articulation mechanisms, onto which the left and right pyrotechnic catapults are connected for use in an emergency for unlocking-releasing the hinge pins, and said articulation mechanisms are configured with the capacity to unlock the fixed and movable segments connected by means of hinges and to release one side thereof which is subsequently pushed upwards by the piston of the catapult provided at that specific side of the movable segment while the opposite side rotates around hinge pins and leans downwards as a result of the weight thereof and folds horizontally at the base thereof on the aircraft tail thereby releasing the space it occupied prior to actuation thereof.

Depending on whether the aircraft is tilted to the left or right side, the clinometer shall activate the corresponding left or right pyrotechnic catapult of the articulation device for the rapid launch of that particular side of the movable segment.

The manufacture material of the vertical fin and articulation of hinges may consist of the exceptionally strong carbon fiber materials for a simpler and strong construction of the accessories of the description below.

The vertical fin may include a rudder wherein at least one segment thereof is provided in the upper movable segment and the other in the lower movable segment of the rudder.

The vertical fin of the invention shall comprise various interconnected segments.
1) the upper movable folding fin segment
2) the upper movable folding rudder segment
3) the lower fixed segment of the fin
4) the lower movable segment of the rudder

The articulation mechanism constitutes a strong base supporting the vertical fin and all internal mechanisms for the unlocking-release of the hinge pins actuated by a pyrotechnic catapult, and said articulation mechanism shall connect internally the upper movable segment to the lower fixed segment of the vertical fin and the upper movable folding rudder segment to the lower movable rudder segment, and thereafter the folding of the upper movable segments shall be executed, and said articulation device comprises:
1) the clinometer
2) the hinges
4) the U-shaped accessory for the release of the hinge pins
6) the pyrotechnic catapult adapted to push-launch the movable fin segment or
7) the catapult equipped with a bowden cable adapted for a pyrotechnic push-launch of the movable fin segment,
8) the antifreeze protection accessory

In an emergency, the ejection handle or the ejection seat activates the clinometer on the articulation-unlocking mechanism of the vertical fin by means of a radio signal or electric signal transmitted through a cable. Depending on the tilt of the aircraft, the clinometer activates the left or right catapult by means of a sensor and cable, resulting in the unlocking of the hinge pins and, subsequently, in an upward pushing action performed by the pyrotechnic catapult and in the launch of one side of the upper movable segments.

After the movable segment of the vertical fin has been unlocked and pushed upwards by means of the piston of the pyrotechnic catapult, there follows the launch of one side of the movable fin segment wherein the opposite side rotates about an X-axis of rotation of the pins of the articulation of hinges and following the launch of one side of the movable segment, said movable segment leans downwards as a result of the weight thereof and folds horizontally at the base thereof on the aircraft tail thereby releasing the space it occupied prior to actuation thereof.

The above-mentioned folding shall be executed by means of:
1) the U-shaped accessory for the release of the hinge pins
2) the pyrotechnic catapult adapted to exert a push, or
3) a pyrotechnic catapult equipped with a bowden cable adapted to push-launch
4) the ejection seat.

### BRIEF DESCRIPTION OF THE DRAWINGS

With reference to the accompanying drawings we will hereinafter describe illustrative preferred embodiments of the invention.

FIG. 1) presents in perspective view the fighter jet with the vertical tail fin of the invention with the rudder that is articulated at the rear end of the aircraft, prior to activation thereof.

FIG. 1A) presents in perspective view the vertical fin of the aircraft illustrated in FIG. 1) prior to activation thereof.

FIG. 2) presents the aircraft illustrated in FIG. 1) with the upper movable segment of the vertical fin being folded together with the rudder, following activation thereof.

FIG. 2A) presents in perspective view details of the interior of the folding vertical fin of the aircraft illustrated in FIG. 2) following activation thereof.

FIG. 3) presents in perspective view the fighter jet with the vertical tail fin of the invention with the rudder that is articulated at the rear end of the aircraft, prior to activation thereof.

FIG. 3A) presents the aircraft illustrated in FIG. 3) as it is whirling with the upper movable segment of the vertical fin being folded together with the upper segment of the rudder, following activation thereof.

FIG. 4) presents in perspective view the vertical fin of the aircraft of the above-mentioned FIGS. 1,1A,2,2A,3,3A) following activation thereof, with the movable tail fin being folded.

FIG. 4A) presents in perspective view the components of the articulation mechanism as they enter the vertical fin of the aircraft.

FIGS. 4B), (4C) present in perspective view the components of the vertical fin with the entry point of the articulation mechanism.

FIG. 4D) presents in perspective view the clinometer which can recognize the direction of the g-forces, namely the combined effect of the gravitational force of the Earth.

FIG. 5) and (6) present in perspective view components of the articulation mechanism with details of their operation prior to and following activation thereof.

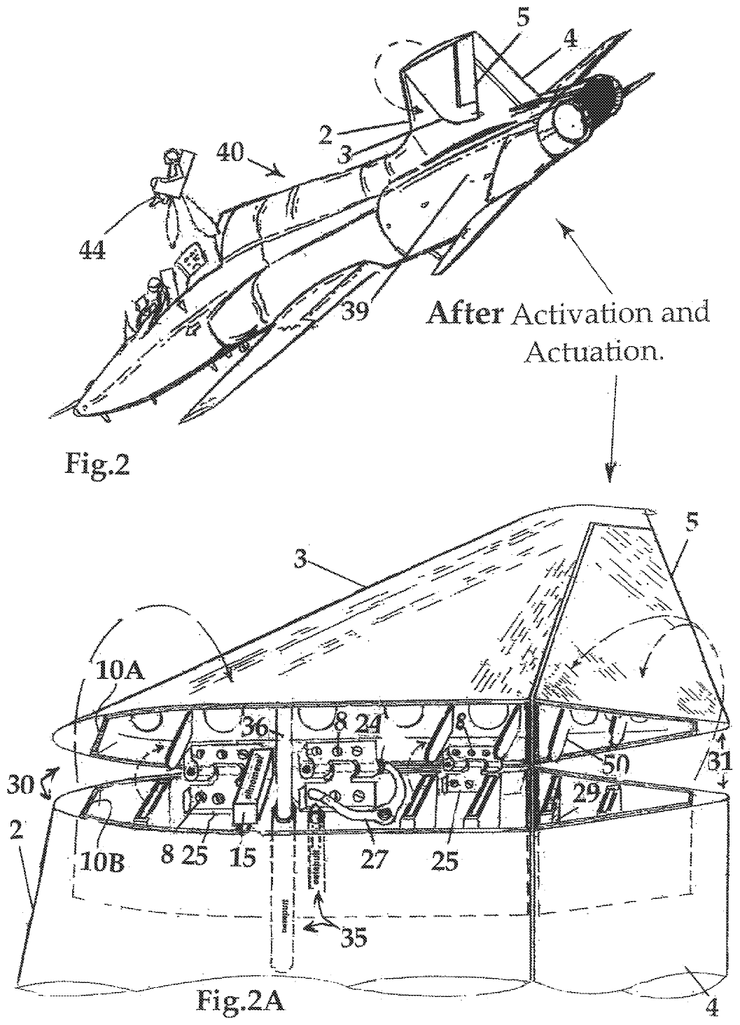

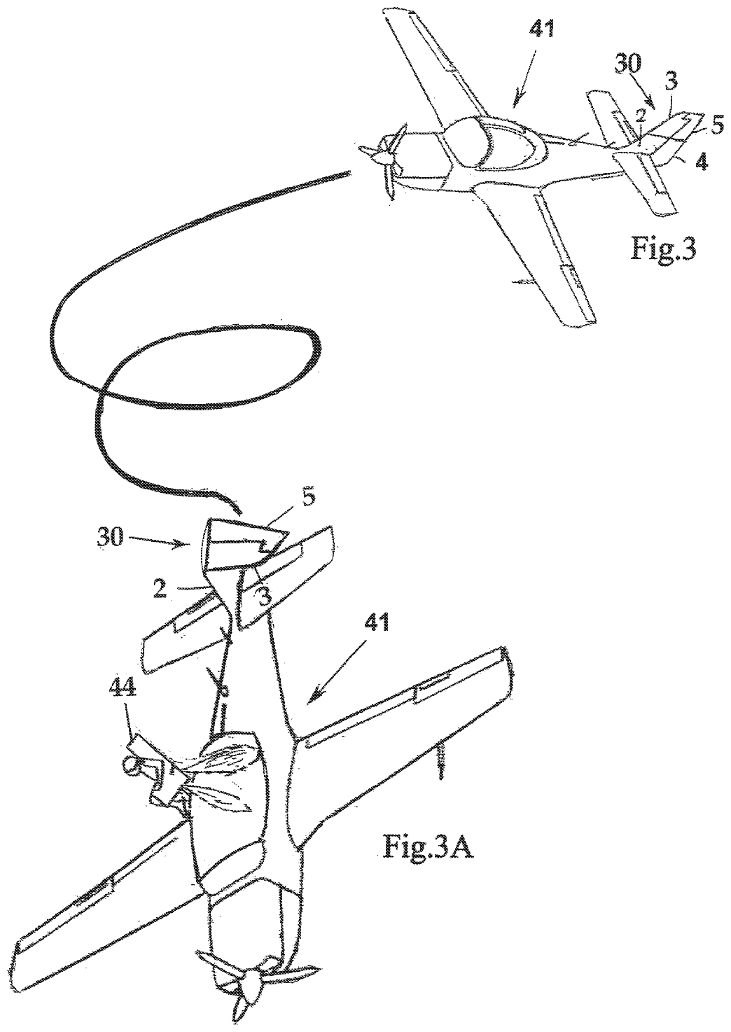

FIGS. 2A,7,8,9,10) present in perspective view the components of the vertical beams that complement the frame of the vertical fin of the aircraft and contribute to its high resistance to strains.

Figures (11,12,13) present in perspective view the components of the pyrotechnic catapult.

FIG. 14) presents in perspective view the components of the pyrotechnic catapult equipped with a bowden cable adapted to perform a mechanical push.

FIGS. 15,16,17) present in perspective view the ejection handle of the ejection seat during an emergency, with said handle directly activating the Clinometer by means of a radio signal or an electrical signal sent through a cable.

### DETAILED DESCRIPTION OF PREFERRED EMBODIMENTS

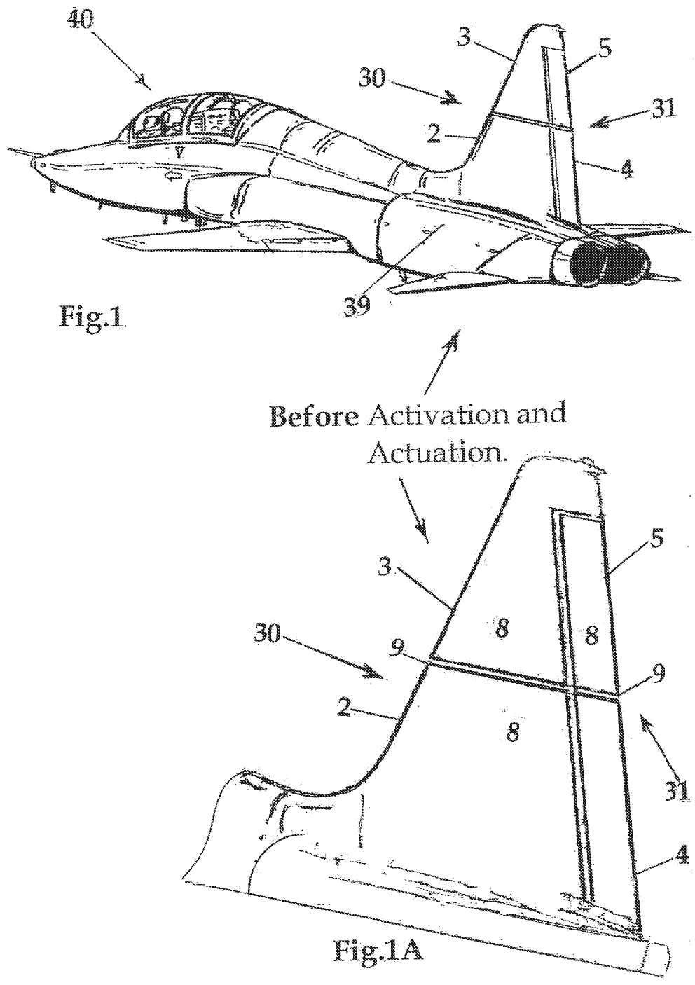

The folding vertical fin (30), FIGS. 1,1A,2,2A,3,3A), mounted on the fuselage tail of the aircraft (40, 41) of the invention, with the internal pyrotechnic catapult (35) thereof connected on both sides of the vertical fin (30), FIG. 2A), is a fully active system contributing to the survival of the pilots during an emergency.

Alternatively, the pyrotechnic catapult (60) equipped with a bowden cable (72) adapted to perform a push may be also connected, FIG. 14).

The vertical fin (30) of the invention, FIGS. 1,1A,2,2A,3,3A), comprises the lower fixed segment (2) and the upper movable segment (3). The movable segment (3) is connected on top of the lower fixed segment (2) and both are connected on both sides, FIG. 2A), by means of an articulation of hinges (25) capable of being released.

The vertical rudder (31) is adapted to form an articulation behind the vertical fin (30) of the aircraft (40) (41), and at least one segment of the rudder (31) is provided in the upper movable segment (5), while a segment of the rudder (31) is provided in the lower movable segment (4).

In an emergency, the ejection handle (47) of the ejection seat (44) of a fighter jet (40) or turbo-prop aircraft (41) activates the clinometer (15) on the articulation-release mechanism (10) of the vertical fin (30), FIG. 1), by means of a radio signal (47a) or an electrical signal (45) sent through a cable. The clinometer (15), equipped with a sensor and a cable, activates the left or right pyrotechnic catapult (35) accordingly, and said pyrotechnic catapult (35), being equipped with a piston adapted to exert a push (36) for the unlocking of the pins (24) of the hinges (25), subsequently launches upwards one side of the upper movable segments (3, 5).

For a more detailed and deeper understanding of the function of each device, the description of each accessory follows.

1) Folding Vertical Fin (30)

FIG. 1) presents as an end product of the invention the vertical fin (30) with the movable tail rudder (31) articulated at the rear end thereof and situated on the rear end of the fuselage (39) of the aircraft (40), (41) prior to activation thereof, illustrating the various interconnected segments:
1) the upper movable (3) folding fin segment (30)
2) the upper movable (5) folding fin segment (31)
3) the lower fixed segment (2) of the fin (30)
4) the lower movable segment (4) of the rudder (31)

FIG. 1A) presents in perspective view the vertical fin (30) of the aircraft (40) of the above FIG. 1) prior to actuation thereof, with the movable tail rudder (31) articulated at the rear end thereof and the distinct contact lines between the upper movable segments (3), (5) and the lower fixed segments (2), (4) of the vertical fin (30) being distinguishable at the points (9), while the threaded rods (8) connecting the upper movable segments (3), (5) to the lower fixed segments (2), (4) by means of the inner articulation mechanisms (10A), (10B) are also distinct.

FIGS. 1,1A,2,2A,3,3A) present in perspective view the various interconnected segments of the vertical fin (30) of the above FIG. 1,1A), illustrating the segments it comprises:
the upper movable (3) folding fin segment (30)
the upper movable (5) folding rudder segment (31)
the articulation mechanism (10A), (10B)
the lower fixed segment (2) of the fin (30)
the lower movable segment (4) of the rudder (31)

The articulation mechanisms (10A), (10B) shall be distributed within and strongly connected to the upper movable segments (3, 5) and the lower fixed segment (2) and lower movable segment (4) of the vertical fin (30).

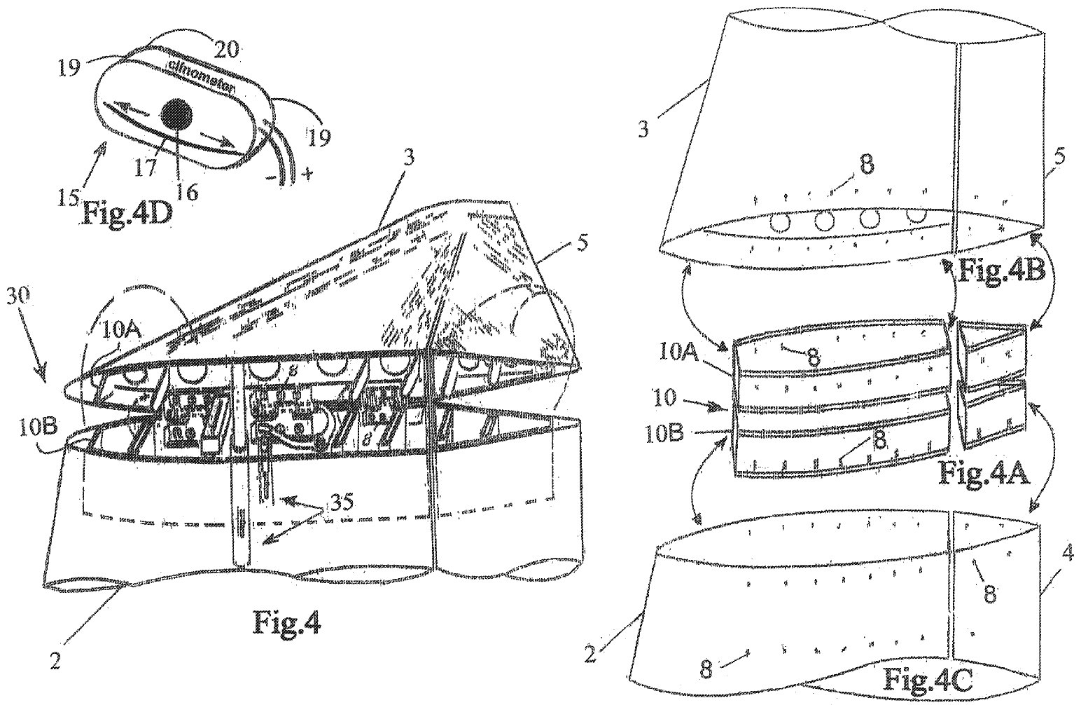

FIG. 4) presents in perspective view the vertical fin (30) of the aircraft (40), (41) of the above-mentioned FIGS. 1,1A,2,2A,3,3A) following activation thereof, with the movable tail fin (5) being folded.

The upper movable fin segment (3), wherein one side of the movable segment is pushed and launched upwards by means of the catapult (35) while the opposite side rotates about the pins (24) of the hinges (25), and the upper movable rudder segment (5), which rotates by means of the fasteners (29) of the vertical beams (50), FIG. 2A), lean downwards as a result of the weight thereof and fold horizontally at the base thereof on the fuselage (39) on the aircraft (40), (41) tail thereby releasing the space the vertical fin (30) occupied previously.

2) Rudder (31)

The folding vertical fin (30) comprises a rudder (31) which is adapted to form an articulation behind the vertical fin (30) of the aircraft (40), (41) wherein at least one segment of the rudder (31), FIGS. 1,1A,2,2A,3,3A) is provided in the upper movable segment (5) and a segment of the rudder (31) is provided in the lower movable segment (4) of said rudder (31). The articulation mechanism (10) comprising double profile supports (10A, 10B) made of carbon, titanium, aluminum, FIGS. 2A,4,4A), is screwed on both sides at the points (9) with the threaded rods (8) connecting the upper movable segment with the lower movable segment by means of the internal articulation mechanism (10) comprising the supports (10A, 10B).

The upper movable folding segment (5) of the rudder (31) is separated from the lower movable segment (4) of the rudder (31) during an emergency by means of the fasteners (29) of the vertical beams (50) of the vertical rudder frame (31), by virtue of the articulation mechanism (10) included therein, FIGS. 2A,4,4A,7,8,9,10).

It consists a strong internal support for the upper movable rudder segment (5) and the lower movable rudder segment (4) and at the point (9) where the upper and lower movable rudder segments (5), (4) are connected it consists a strong base for support-connection by means of the fasteners (29) of the vertical beams (50).

The upper movable segment (5) is released from the lower movable segment (4) at the points (9) of the vertical rudder (31) by means of fasteners (29) made of strong metal plate or carbon fiber, etc., in the shape of a double U. The fastener (29) tightly connects within the two adjoining ends of the vertical beams (50), FIGS. (2A,7,8,9,10), in a way that they become separated when the catapult adapted to exert a push (35) pushes towards the upper movable segment (3) by means of the internal piston (36) thereof, resulting in the launch of one side of the movable folding segment (3) of the fin (30) and of the upper movable rudder segment (5) which is adapted to form an articulation behind the upper movable segment (3) of the folding vertical fin (30) and, subsequently, said movable segment (5) follows said movable segment (3) as it rotates and leans downwards towards the lower fixed fin segment (2) and the lower movable rudder segment (4).

3) Articulation Mechanism (10)

FIGS. 2A, 4, 4A) present in perspective view the articulation mechanism (10) comprising the segments (10A, 106) which shall be distributed within and strongly connected to the upper movable segment (3) and the lower fixed segment (2), FIGS. (46,4C), of the vertical fin (30), and the articulation mechanism (10) executes the unlocking of the connection points to the upper movable segment (3) and lower fixed segment (2) and the release of the pins (24) of the hinges (25) of the vertical fin (30). Moreover, the pyrotechnic catapult (35) adapted to push-launch is strongly connected onto the articulation mechanism (10) within the movable segment (3).

The articulation mechanism (10), FIGS. 2A,4,4A), consists an overall strong internal strengthening of the vertical fin (30) at the point where the upper movable segments (3, 5) and the lower fixed segments (2, 4) are connected within and consists a strong base for the support and connection of all mechanisms.

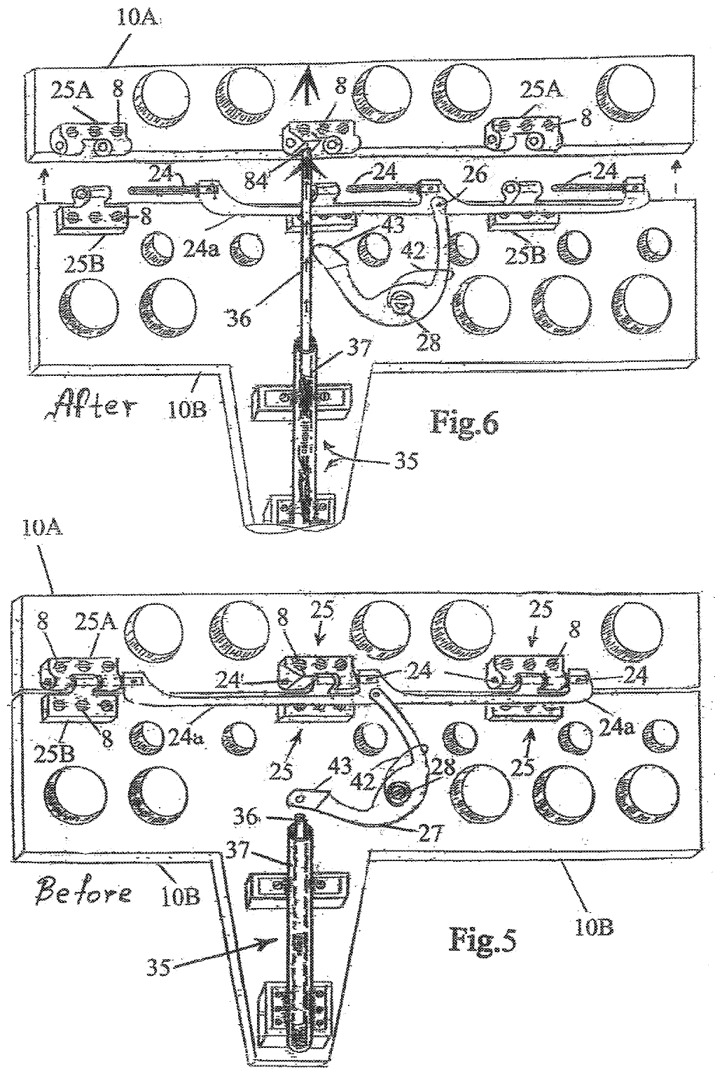

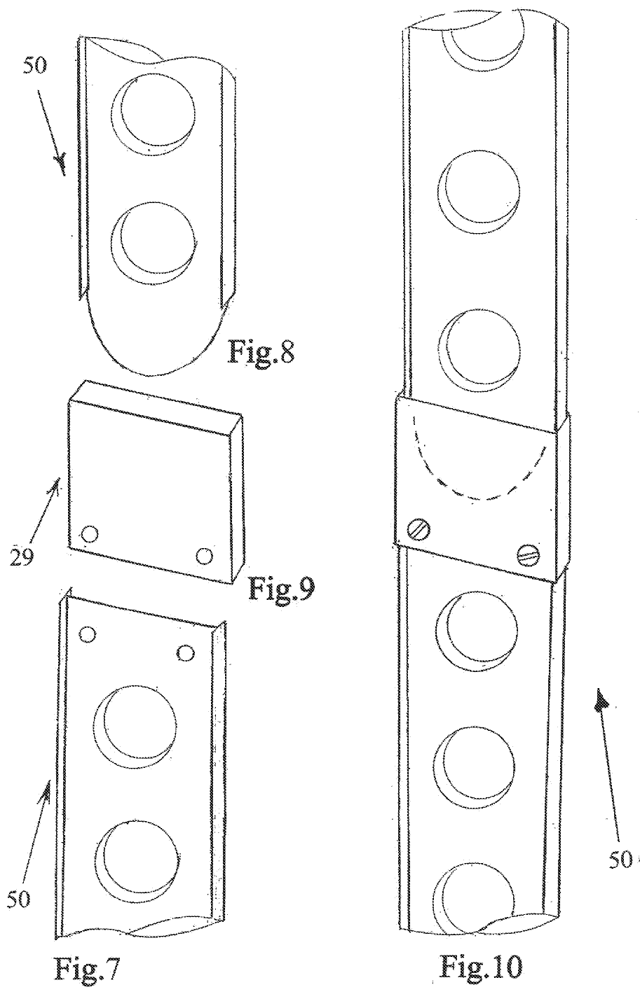

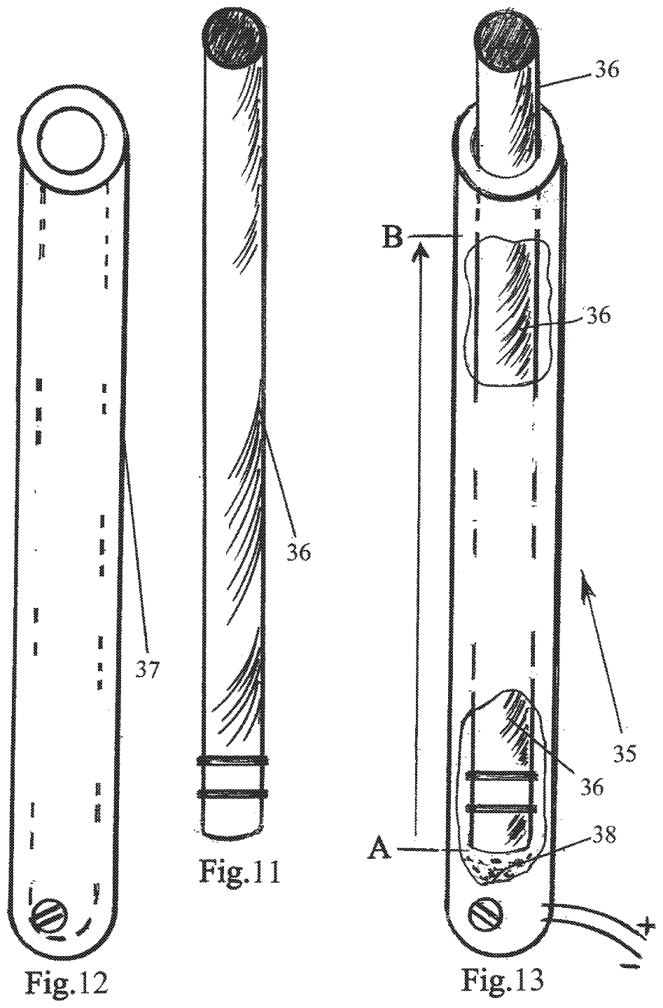

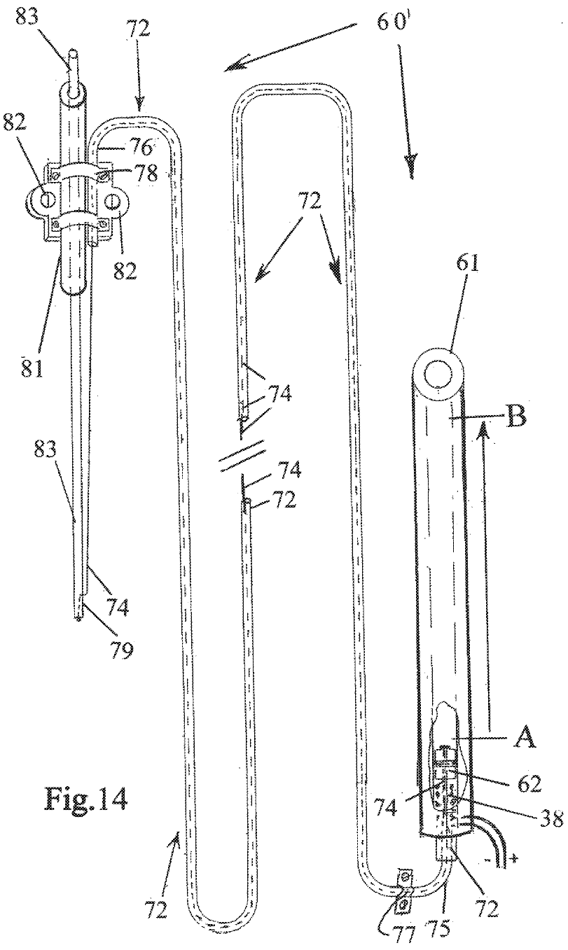

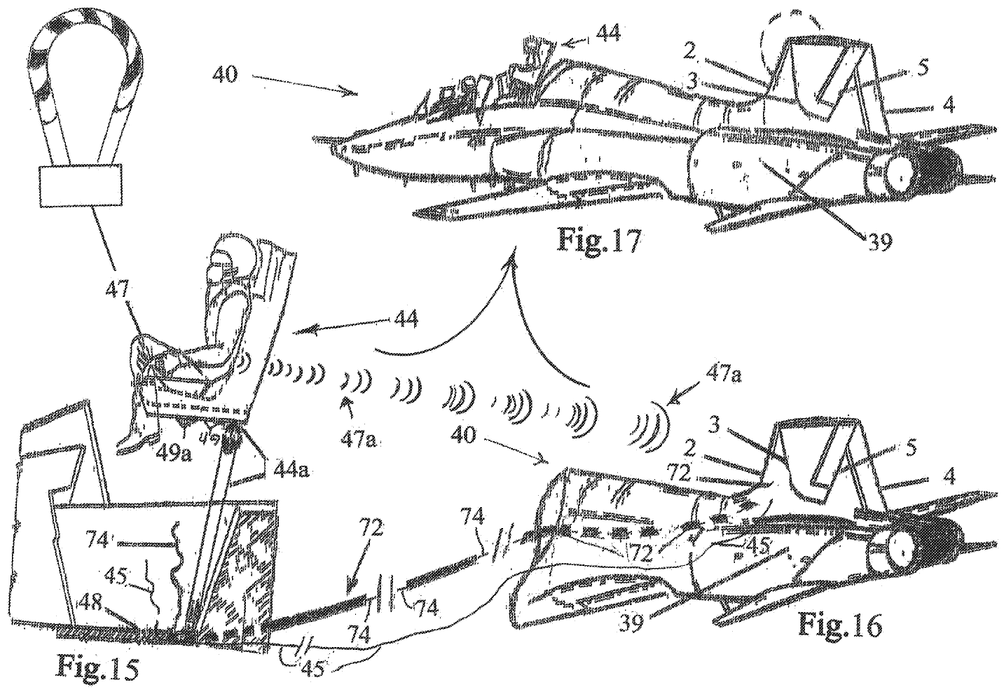

In principle, it comprises strong, horizontal and double parallel (10A, 106), upper and lower double profile supports, FIG. 5) and (6), made of carbon, titanium, aluminum, which extend horizontally within the vertical fin (30) and are connected parallel to each other by means of the pins (24) of the hinges (25), FIGS. 2A, 4) extending between a front edge and a rear edge of the vertical fin (30).

FIG. 5) and (6) present an indicative detail of the horizontal and double parallel (10A, 10B) strong supports of the articulation mechanism (10) prior to and following actuation thereof along the larger portion of one side of the fin. More specifically, FIG. 5) presents the upper and lower mounting plates (10A, 10B), which are connected parallel to each other by means of the pins (24) of the hinges (25), before activation thereof.

Additionally, the pyrotechnic catapult (35) equipped with the inner tube-piston (36) adapted to push-launch is strongly connected within the movable segment (3) onto the articulation mechanism (10) and the support (10B), and said pyrotechnic catapult (35) as shown in FIG. 6) pushes by means of the inner tube-piston (36) thereof the U-shaped accessory (27) at the point (43) following actuation thereof, wherein said accessory (27) executes the unlocking of the connection points and the release of the pins (24) of the hinges (25).

As the pins (24) are being removed from the hinge knuckle, they unlock-release the upper movable segment from the lower fixed segment of the vertical fin (30) of the aircraft (40).

This is achieved, FIG. 6), with the other end (43) of the principal U-shaped accessory (27) as it is being pushed with the inner shaft-piston (36) by the pyrotechnic catapult (35) adapted to perform a pushing action. Immediately thereafter, the pyrotechnic catapult (35) pushes with its inner shaft-piston (36) towards a strong steel [socket] (84) and the parallel (10A, 10B) strong supports of the articulation mechanism (10) are rapidly separated on one side together with the upper movable segment (3) of the fin (30) and the upper movable folding segment (5) of the rudder (31).

4) Clinometer (15)

The clinometer (15) or ball inclinometer (16) or tilt indicator, FIGS. 2A,4,4D) shall be the useful mechanical device that recognizes the direction of g-forces, namely the combined effect of the force of Earth's gravity and any tilt or turning force, and it shall require a source of electrical energy to generate and transmit a signal indicating a tilt to the left or right side of the aircraft (40, 41). The clinometer (15) receives via the receiver (20) thereof a radio signal (47a) or electrical signal (45) sent through a cable, said signal being produced by the ejection handle (47) of the ejection seat (44) and directed at the left or right pyrotechnic catapult (35) adapted to exert a push, said catapult being connected to the articulation-unlocking mechanism (10) of the vertical fin (30). It is simply a small ball (16) that moves freely like a pendulum, but in a bent tube (17). During straight and level flight, when the aircraft is calibrated, it shall rest at the center (18), at the lowest point of the tube (17). Should there be any tilt or slip angle, the ball (16) shall move towards the same side where the tilt or slip takes place. Any side force or tilt (slip or skid) shall also apply to the clinometer (15). Within the bent tube (17), at the right and left extremities thereof, there are electrical contacts (19) which close when the ball (16) touches them. The electrical signal of the tilt sensor (20) of the clinometer (15) actuates within the vertical fin (30) of the aircraft (40, 41) the left or right pyrotechnic catapult (35) adapted to perform a pushing action. Thanks to recent developments in micro-electromechanical systems technology, the size of the sensor (20) may be reduced dramatically to the size of a microchip.

5) Hinges (25)

The hinges (25), FIGS. 2A,4,5,6) comprise two segments forming one accessory by means of the pins (24). They are fastened with screws and mounted on the main supports (10A, 10B) on both sides of the articulation mechanism (10) and connect the upper movable folding segment (3) of the fin (30). The hinges (25) of the articulation mechanism (10) connect the base of the upper movable folding segment (3) at the left and right side thereof to the lower fixed segment (2) of the fin (30), FIGS. (1A,2A,3,4,5,6) for attachment to the fuselage (39) of the aircraft (40, 41), by means of the pins (24) of the hinges (25) which are capable of releasing said hinges (25) by means of the U-shaped accessory (27). The hinges (25) on the articulation mechanism (10) of the fin (30) extend between a front edge and a thereafter attachment until the end as well as onto the main supports (10A, 10B) of the articulation mechanism (10) More specifically, the articulations of hinges (25) extend onto the main supports (10A, 10B) of the articulation mechanism (10) on both sides of the fin (30).

The pins (24) capable of releasing the hinges (25), FIGS. 2A,4,5,6), are connected at one end thereof by means of the U-shaped accessory (27) which is capable of pulling said pins (24) thereby removing them and releasing the two hinge components (25), given that the other end of said pins (24) is free.

6) U-Shaped Accessory (27) for the Release of the Pins (24)

The U-shaped accessory (27), FIGS. 2A,4,5,6), is the principal accessory for the unlocking-release of the pins (24) of the hinges (25) and is actuated by the push exerted by the catapult (35). The connection screw (28) capable of rotating freely on the articulation device (10) by means of a strong spring (42), FIGS. 4,5,6) passes through the bottom bent portion of the accessory (27), FIGS. 5,6) at the lower fixed segment (2) of the fin (30) and said U-shaped accessory (27) is made of strong metal shaped like a wide U.

The U-shaped accessory (27), FIGS. 2A,4,5,6), contains and locks the two hinge portions (25A), (25B), FIGS. (4,5), by means of a strong spring (42) exerting pressure on one end (26) of said U-shaped accessory (27).

The pins (24) of the hinges (25) are connected with one end thereof to the rod-plate (24a) whose entire length extends adjacent to the hinges (25), FIGS. 5,6), and the U-shaped accessory (27) is connected with one end (26) thereof to the pins (24) of the hinges (25) as stated above and is capable of rapidly releasing all the connected pins (24) simultaneously with the release of the above first pin (24).

The principal U-shaped accessory (27) for the unlocking-release of the pin (24) of the hinges (25), FIGS. 5,6), is capable by virtue of its shape to rapidly pull the end of the pins (24) of the hinges (25) by means of the rod-plate (24a) as it rotates about the connection screw (28).

As the pins (24) are pulled out of the hinge knuckles, they unlock-release the upper movable segment from the lower fixed segment of the fin (30) of the aircraft (40), (41).

This is achieved, FIG. 6), with the other end (43) of the principal U-shaped accessory (27) as it is being rapidly pushed by the inner shaft-piston (36) of the pyrotechnic catapult (35) adapted to perform a pushing action. Rapidly thereafter, the catapult (35) adapted to perform a pushing action by means of its inner shaft-piston (36) pushes towards the strong steel socket (84) provided on the upper movable folding segment (3) of the fin (30), and upper movable folding segment (5) of the rudder (31).

7) Vertical Beam (50) Fasteners (29)

The vertical beams (50), FIGS. 2A,7,8,9,10), complement the frame (45) of the vertical fin (30) of the aircraft (40,41) and contribute to the strong resistance thereof to strains.

The upper movable folding segment (3) of the fin (30) and the upper movable folding segment (5) of the rudder (31) are separated during an emergency from the lower fixed segment (2) of the fin (30) and the lower segment (4) of the rudder (31) by means of the fasteners (29), FIG. 9), of the vertical beams (50) of the frame of the vertical fin (30) thereby releasing the upper movable segments (3, 5) from the lower fixed and movable segments (2, 4) of the vertical fin (30), with the point of separation thereof being the fasteners (29), FIG. 9), which consist of strong metal plate or carbon fiber, etc., in the shape of a double U. The fastener (29) tightly connects within the adjoining ends of two vertical beams (50), FIGS. 2A,7,8,9,10), in a way that they become separated as they rotate when the catapult (35) adapted to exert a push pushes upwards towards the upper movable segment (3) by means of the inner piston (36) thereof, resulting in the launch of one side of the folding movable segment (3) of the fin (30), followed by the rotation occurring about the pins (24) of the hinges (25) and the rotation of the vertical beams (50) by virtue of the fasteners (29), FIGS. 9, 10) positioned on the opposite side of the folding movable segment (3), with said folding movable segment (3) then leaning downwards.

8) Pyrotechnic Catapult (35) Adapted to Perform a Push

The Pyrotechnic catapult (35) adapted to perform a pushing action is connected onto the articulation device (10) attached to the upper movable folding segment (3) or the lower fixed segment (2) of the vertical fin (30) of the aircraft (40,41).

The pyrotechnic catapult (35), FIG. 13), comprises two steel tubes (36, 37), FIGS. 11,12), wherein the diameter of one is smaller so that it enters the other with a snug fit, FIG. 13).

During an emergency, the ejection handle (47) of the ejection seat (44) initiates the ejection process and at the same time activates the Clinometer (15) on the articulation device (10) of the vertical fin (30) via a radio signal (47a) or electrical signal (45) sent through a cable, and said Clinometer (15) actuates the pyrotechnic catapult (35) adapted to exert a push which pushes upwards with the inner piston thereof comprising a special steel tube (36) and unlocks the movable segment (3) by means of the U-shaped accessory (27), FIGS. 2A,4,5,6), which constitutes the principal accessory for the unlocking-releasing of the pins (24) of the hinges (25).

Subsequently, a small upward push is exerted by means of the steel tube (36) of the catapult (35) towards the strong steel socket (84) of the upper movable segments (3), (5), followed by the launch of one side thereof and the rotation about the pins (24) of the hinges (25) of the opposite side, FIGS. 2A,4,5,6), resulting in said movable segments (3), (5) leaning downwards as a result of the weight thereof and folding horizontally at the base thereof on the tail of the aircraft (40, 41) thereby freeing the space the vertical fin (30) occupied previously.

The propulsion charge may consist of a gas cartridge actuator (38) equipped with an electric starter which generates a defined volume of gas for a rapid mechanical displacement.

The gas generation time is 700-1000 milliseconds with the potential to achieve varying flow rates.

A pyrotechnic actuator (or an explosive piston actuator) may push and launch the piston (36) from point A to point B, FIG. 13), using the energy provided by the gases being produced from the burning of the propulsive charge thereby initiating a mechanical action, and they may be actuated by means of electric detonators.

9) Pyrotechnic Catapult (60) Adapted to Exert a Push by Means of a Bowden Cable (72)

The pyrotechnic catapult (60) adapted to exert a push by means of a bowden cable (72), FIG. 14), differs in that it comprises two separate portions with only the pyrotechnic catapult (61) being attached outside the vertical fin (30) at any suitable place on the fuselage of the aircraft (40, 41). Thus, only the small cylinder (81) equipped with a bowden cable (72) is connected within the vertical fin (30), in which case the catapult is simpler in design as the vertical fin (30) is not equipped with a pyrotechnic catapult (60).

The small cylinder (81) equipped with a bowden cable (72) is connected onto the articulation mechanism (10) of the upper movable folding segment (3) or the lower fixed segment (2) within the vertical fin (30) and comprises the outer, strong, small cylinder (81) which is open at both ends thereof and with strong connection points (82) onto the articulation mechanism (10), and the piston rod (83) passes through said cylinder with the lower end (79) thereof connected to the lower end of the inner wire cable (74) of the bowden cable (72).

The remote system of force transmission-control with a bowden cable (72) takes advantage of the energy resulting from the abruptly exerted force during the pulling action caused by the pyrotechnic push of the Pyrorechnic steel cylinder (61).

The catapult (60) equipped with a bowden cable (72) takes advantage of the abrupt force exerted whilst the inner steel cable (74) encased within the bowden cable (72) is being pulled by the small piston (62) contained within the Pyrotechnic steel cylinder (61).

Within the Pyrotechnic steel cylinder (61) there is the small piston (62) whose diameter is smaller so that it enters the Pyrotechnic steel cylinder (61) fitting snugly. The end of the steel cable (74) enters within the Pyrotechnic steel cylinder (61) and is connected to the bottom of the small piston (62) to exert the pull. The propulsion charge may consist of a gas cartridge actuator (38) equipped with an electric starter which generates a defined volume of gas for a rapid mechanical displacement.

The gas generation time is 200-1000 milliseconds with the potential to achieve varying flow rates.

A pyrotechnic actuator (or an explosive piston actuator) is capable of pushing and launching a piston from point A to point B by exploiting the energy generated by the gases produced from the burning of the propulsion charge for the initiation of a mechanical action. It can be actuated using electrical detonators.

The pulling assembly equipped with a Bowden cable (72), comprising a plastic outer casing and a flexible cable of composite manufacture as well as an inner helicoid, twisted steel wire (74), is attached via the two ends of the outer plastic casing (75, 76) to a pair of respective fixed anchor points (77, 78) on the fuselage (39) of the aircraft (40,41).

The linear movement of the inner bowden cable (74) is commonly used with a field of force transmission when one of the ends (75) of the inner cable is being pulled towards the other end (76) thereof when the remote transmission of force is required between two fixed anchor points (for instance in bicycles where bowden cables make up the brake lever, the cable connecting individual machine elements, the clutch cable; such a cable is referred to as a bowden cable, however certain individual properties may be attributed to an “X cable” or “X linkage” as appropriate) wherein force is ultimately transferred to the catapult system (60) in the form of a push force thereby functioning as a mechanical control cable capable of an alternative push-pull configuration, so that a push exerted towards a certain direction produces a push force towards an opposite direction at the other end (79) thereof.

The principal mechanical structure of the cables (wire ropes) (74) comprises a bundle of two or more cables twisted together. The structure is usually referred to as (1×) the number of wires or ropes or cables that are connected, namely (1×7) (7 wires) or (1×19) (19 wires), etc.

This is the aspect of the principal structure that is used in different combinations for the construction of a different version using different cables.

This type of structure has applications in aviation, automobiles, instruments, etc., and various properties designed for special applications.

The proposed assembly equipped with a bowden cable (72), FIG. 14), bears the inner wire cable (74) made of stainless steel. For every portion of the bowden cable (72) assembly, there are at least two strong, fixed anchor points (77), (78) within the aircraft for the linear, longitudinal motion of the inner wire cable (74) over distances, particularly around corners.

The present invention concerns a proposal for the transmission of motion-transfer of force over a curved route as presented in FIG. 14) with the use of a flexible bowden cable (72) More specifically, in such an autonomous, remote system of transmission-control of force, the catapult (60) takes advantage of the energy resulting from the abruptly exerted force during the pulling of the inner wire cable (74) of the bowden cable (72) actuated within the Pyrotechnic steel cylinder (61).

By virtue of the flexibility thereof, it can be routed above or under obstacles with functional reliability. The Bowden cable (72) requires no maintenance as it does not transmit noise or shock and it is quite flexible with a wide array of accessories suitable for use with the inner core cables.

In the present invention, provision has been made for the adjustment of the tension of the cable using an integrated, revolving, hollow adjustment screw which elongates or shortens the casing of the cable relative to its fixed anchorage points. The elongation or shortening of the connection is achieved with the twisting of the adjustment screw that tightens or loosens the cable. Additionally, the design and information related to the mechanical manufacture of the core of the cables (wire ropes) made of stainless or galvanized steel may include wire, rope, or cable.

10) Ejection Seat (44) Adapted to Pull the Bowden Cable (72) of the Catapult (60)

The ejection handle (47) of the ejection seat (44), FIGS. 15,16,17), of the aircraft (40,41) has the capacity during an emergency to activate directly the Clinometer (15) which receives a radio signal (47a) or electrical signal (45) sent through a cable.

The process is exactly the same as with the above-mentioned description incorporating the bowden cable (72) except for the Pyrotechnic cylinder (61) which is now replaced by the ejection seat (44).

By virtue of its flexibility, the bowden cable (72) may be routed above or under obstacles and around corners without intermediary links or pulleys with functional reliability.

The inner wire cable (74) of the bowden cable (72) is connected underneath the ejection seat (44) at the connection point (49a) and during ejection, as the wire cable (74) is being pulled by a predefined force, the end thereof is cut off as happens currently with the ejection seat pulling the pilot's legs back during ejection.

Is should herein be noted that the force required by the catapult (60) of the vertical fin (3) to fold said vertical fin (30) shall be extracted-subtracted from the catapult (44a) of the ejection seat (44) and said extracted force is small and depends on the size of the aircraft and the angle of inclination, however the approximate extracted force in kg is translated into newtons and ranges from 10 to 30 N.

11) Antifreeze Accessory (21)

For this specific point of connection of the articulation device (10), the antifreeze accessory (21) equipped with a resistor (22) is added within between the upper movable segment (3) and the lower fixed segment (2) of the vertical fin (30) to protect from frost and to safely separate the fin segments. The articulation mechanism (10) is the principal support for all the hinge mechanisms for the unlocking-release of the pins (24) of the hinges (25), as well as for the pyrotechnic catapult (35) adapted to exert a push. For this specific connection point of the articulation device (10), there are the distinct contact lines at the points (9) between the upper movable segments (3, 5) and the lower fixed segments (2, 4) of the vertical fin (30) to protect from frost and to safely separate the segments.

12) Ejection Handle (47) for the Ejection Seat (44)

As the fighter jet (40) or turbo-prop aircraft enters a state of emergency, the ejection handle (47) of the ejection seat (44), FIGS. 15,16,17), simultaneously activates the receiver (20) of the Clinometer (15) via radio signal (47a) or electrical signal (45) transmitted though a cable and said Clinometer (15), positioned on the articulation mechanism (10) within the vertical fin (30), in turn actuates the pyrotechnic catapult (35) adapted to exert a push for the ensuing folding of the vertical fin (30); alternatively, actuation causing the folding of the fin (30) is executed underneath the ejection seat (44) by means of a radio signal (47a) or electrical cable (45) equipped with a switch (49), wherein said electrical cable is connected between the ejection set (44) and the cockpit floor (48) as well as to the clinometer (15) and said cable is subsequently cut off with the application of a predefined small force which translates into 10 newtons approximately.

It should herein be noted that the description of the invention was made by reference to illustrative examples of application to which it is not limited. Thus, any alteration or modification regarding the described forms, sizes, configurations, materials, and accessories of construction and assembly, techniques applied in the construction and operation of the elements of the invention, as long as they do not constitute a new inventive step and do not contribute to the technical development of the already known, are considered part of the scope and the aims of the present invention, as briefed in the following Claims.

1. Folding vertical fin (30), rudder (31) of a fighter jet (40), turbo-prop aircraft (41) equipped with a catapult within the vertical fin (30), and said vertical fin (30) comprises: the lower fixed segment (2) being configured for attachment onto a fuselage (39) of an aircraft (40), (41), and the upper movable segment (3) being configured to connect to said fixed segment (2) at the points (9), and said vertical fin (30) comprises a rudder (31) which is adapted to form an articulation behind said fin (30), wherein at least one segment of said rudder (31) is provided at the upper movable segment (5) and a segment is provided at the lower movable segment (4) being configured to connect to the points (9) of said vertical rudder (31), and the articulation mechanism (10) is screwed on both sides of said vertical fin (30) and said rudder (31) at the points (9) and said articulation mechanism (10) comprises double profile supports (10A, 10B) made of carbon, titanium, aluminum, for the connection of movable segments (3),(2),(5),(4) by means of articulations of hinges (25) extending on both sides between a front edge and a rear edge of said vertical fin (30) and said rudder (31), and the articulation mechanism (10) being screwed by means of threaded rods (8) to the upper movable segment (3) and to the lower fixed segment (2) as well as to the upper movable segment (5) and to the lower movable segment (4), and said aircraft (40), (41), the ejection handle (47) of the ejection seat (44) in parallel with the ejection of the seat (44) activates, via a radio signal (47a) or electrical signal (45) sent through a cable, the radio receiver (20) of the Clinometer (15) attached to the articulation mechanism (10) of the vertical fin (30), and said Clinometer (15) actuates the left or right pyrotechnic catapult adapted to exert a push within said vertical fin (30), and the catapult piston pushes the U accessory (27) which is capable of releasing the connection provided by the articulation mechanism (10) and extracting the pins (24) of the hinges (25) separating one side of the upper movable segment (3) from the lower fixed segment (2) of said vertical fin (30), and subsequently the catapult pushes rapidly by means of the piston thereof towards the strong steel socket (84) of the upper movable segment (3), and wherein the released said articulation allows the movable segment (3) and the opposite side thereof to rotate freely around the hinges (25) relative to the fixed segment (2), and simultaneously the vertical beams (50) rotate as they are released by means of the fasteners (29) resulting in said movable segment (3) of said vertical fin (30) and said upper movable segment (5) of said rudder (31) folding horizontally at the base thereof on the fuselage (39) at the tail of the aircraft (40), (41) thereby freeing the space the occupied previously.

2. A folding vertical fin (30), rudder (31) of a fighter jet (40), turbo-prop aircraft (41) equipped with a catapult within the vertical fin (30), according to claim 1), characterized in that it comprises an articulation mechanism system (10) for the strong connection of the upper movable segments (3, 5) and lower fixed segments (2, 4) and a strong base for connecting hinges (25) with pins (24), a clinometer (15), the U-shaped accessory (27) for the release of the pins (24) of the hinges (25), an antifreeze protection accessory (21), the pyrotechnic catapult capable of releasing and folding the upper movable segments (3, 5) of said vertical fin (30).

3. A folding vertical fin (30), rudder (31) of a fighter jet (40), turbo-prop aircraft (41) equipped with a catapult within the vertical fin (30), according to claim 1), characterized in that said clinometer (15) equipped with a ball (16) picks up the tilt angle of the aircraft (40), (41) and proceeds to actuate the left or right pyrotechnic catapult (35) by means of the pyrotechnic actuation (38) of the inner tube-piston (36) thereof, thereby moving the upper movable segment (3) of the vertical fin (30) as well as the upper movable segment (5) of the rudder (31).

4. A folding vertical fin (30), rudder (31) of a fighter jet (40), turbo-prop aircraft (41) equipped with a catapult within the vertical fin (30), according to claim 1), characterized in that said folding vertical fin (30) comprises a fixed segment (2) attached to the fuselage of the aircraft (40), (41), and a movable segment (3) connected to the fixed segment (2) by means of an articulation of hinges (25) on both sides wherein the articulation has been configured to allow the movable segment (3) to rotate freely around the hinges (25) relative to the fixed segment (2) when the articulation mechanism system (10) releases one side of the articulation of hinges (25) on the movable segment (3) relative to the fixed segment (2) by means of a catapult adapted to exert a push.

5. A folding vertical fin (30), rudder (31) of a fighter jet (40), turbo-prop aircraft (41) equipped with a catapult within the vertical fin (30), according to claim 1), characterized in that the activation of the Clinometer (15) on the articulation mechanism (10) of the vertical fin (30) is achieved by means of a radio signal (47a) or electrical signal (45) sent through a cable by the ejection handle (47) of the ejection seat (44), and said Clinometer (15) with the receiver (20) thereof receives the radio signal (47a) or electrical signal (45) sent through a cable and actuates the pyrotechnic catapult (35) adapted to exert a push for the folding of the fin (30).

6. A folding vertical fin (30), rudder (31) of a fighter jet (40), turbo-prop aircraft (41) equipped with a catapult within the vertical fin (30), according to claim 1), characterized in that the activation of the Clinometer (15) on the articulation mechanism (10) of the vertical fin (30) is achieved by means of a radio signal (47a) or electrical signal (45) sent by the ejection seat (44) through a cable, said cable being connected between the ejection seat (44) and the floor (48) by means of a switch (49) and subsequently being cut off by a predefined small force of approximately 10 newtons, and said Clinometer (15) equipped with a receiver (20) receives the radio signal (47a) or electrical signal (45) sent through a cable and actuates the pyrotechnic catapult (35) adapted to exert a push for the folding of the fin (30).

7. Folding vertical fin (30), rudder (31) of a fighter jet (40), turbo-prop aircraft (41), equipped with a catapult within the vertical fin (30), according to claim 1, characterized in that said clinometer (15) equipped with a ball (16) picks up the tilt angle of the aircraft (40), (41) for the activation of the left or right small cylinder (81) of the catapult equipped with a piston rod (83), wherein the bottom end of the inner wire cable (74) of the bowden cable (72) is connected to the lower end (79) of said piston rod (83) for the transmission of the force resulting from the abruptly exerted force as the bowden cable (72) is being pulled and which is caused by the pyrotechnic push of the pyrotechnic steel tube (61), and said pyrotechnic tube (61) of said catapult (60) is connected to the fuselage (39) of the aircraft (40), (41) outside the vertical fin (30).
The small piston (62), which is connected to the end of the bowden cable (72) at the bottom end thereof for the purpose of pulling the inner steel cable (74), goes through the pyrotechnic tube (61) fitting snuggly. The propulsion charge may consist of a gas cartridge actuator (38) equipped with an electric starter which generates a defined volume of gas for a rapid mechanical displacement.

8. A folding vertical fin (30), rudder (31) of a fighter jet (40), turbo-prop (41) aircraft equipped with a catapult within the vertical fin (30), according to claim 1), characterized in that the ejection handle (47) initiates the ejection of the ejection seat (47) while at the same time, via radio signal (47a) or electrical signal (45) sent through a cable, activating the radio receiver (20) of the clinometer (15) fitted on the articulation mechanism (10) of the vertical fin (30) and, simultaneously, the seat (44) pulls the attached wire cable (74) of the bowden cable (72) and actuates the left or right cylinder (81) of the catapult (60) equipped with a piston rod (83), wherein the connection of the cable (74) is achieved by means of the connection (49a) underneath the seat (44) and the connection on the floor (48), and as the seat (44) is being ejected, the end of the wire cable (74) of the bowden cable (72) is cut off by means of a predefined pulling force.
